(19) United States
(12) Patent Application Publication
(10) Pub. No.: US 2004/0210864 A1
(43) Pub. Date: Oct. 21, 2004

(54) Instruction form retrieval apparatus, instruction form execution apparatus, instruction form management system and instruction form retrieval method

(75) Inventors: Keiko Shiraishi, Atsugi-shi (JP); Yasuo Tanaka, Kawasaki-shi (JP); Tomonari Yamauchi, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD, TOKYO (JP)

(21) Appl. No.: 10/662,337

(22) Filed: Sep. 16, 2003

(30) Foreign Application Priority Data
Mar. 24, 2003 (JP) 2003-081354

(51) Int. Cl. G06F 9/44

(52) U.S. Cl. 717/100

(57) ABSTRACT

There are provided an instruction form retrieval apparatus for retrieving an instruction form accessible to a user based on information on the user, an instruction form execution apparatus, an instruction form management system having the instruction form retrieval apparatus and the instruction form execution apparatus, and an instruction form retrieval method for retrieval of the instruction form accessible to the user based on information on the user. An instruction form retrieval apparatus of an instruction form management system retrieves information on an instruction form management apparatus holding an instruction form accessible to a user, based on information on the user, and transmits information on the instruction form management apparatus to an instruction form execution apparatus. The instruction form execution apparatus accesses an instruction form management apparatus based on the information on the instruction form management apparatus, and the instruction form management apparatus transmits the instruction form accessible to the user.

### BACKGROUND OF THE INVENTION

1. Field of the Invention

The present invention relates to an instruction form retrieval apparatus, an instruction form execution apparatus, an instruction form management system and an instruction form retrieval method, and more particularly, to an ins on form retrieval apparatus for retrieval of an instruction form, an instruction form execution apparatus for execution of processing indicated in the instruction form, an instruction form management system having the instruction form retrieval apparatus and the instruction form execution apparatus, and an instruction form retrieval method for retrieval of the instruction form.

2. Description of Related Art

In a case where a user performs processing by a personal computer or the like, there is no problem if all the processing is completed by the users instruction at once, however, if (1) a file downloaded via a network is (2) converted into another format file, then (3) is transmitted to a PDA or the like which handles only files in the format, the user instructs the personal computer to perform the processing (1), then checks the completion of the processing and instructs the personal computer to perform the processing (2), then checks the completion of the processing and instructs the personal computer to perform the processing (3). That is, the user independently performs the processes (1) to (3). In such a case, if the number of processes increases, the load on the user and waiting time increase.

To reduce the load on the user and the waiting time, an instruction form, which indicates processing to be performed by the personal computer or the like, can be used (e.g., see Patent Reference 1). In this case, the user generates an instruction form indicating execution of processes (1) to (3), and issues a command to the personal computer to execute the processes in the instruction form. The personal computer executes the processings (1) to (3) indicated in the instruction form by the users issuance of command at once.

[Patent Reference 1]

Japanese Published Unexamined Patent Application No. Hei 11-331446

In a case where the instruction form is stored in the personal computer used by the user, the user can easily access the instruction form. However, if the instruction form is stored in another device (i.e., a personal computer different from the user's personal computer, a storage device or the like), the user (1) detects the device holding the instruction form, then (2) connects the user's personal computer to the detected device via the network, and (3) accesses the instruction form. The access to the instruction form via multiple steps impairs the advantage of the instruction form of reduction of the load on the user and waiting time.

### SUMMARY OF THE INVENTION

The present invention has been made in consideration of the above situation, and provides an instruction form retrieval apparatus for retrieval of an instruction form accessible to a user based on user information, an instruction form execution apparatus, an instruction form management system having the instruction form retrieval apparatus and the instruction form execution apparatus, and an instruction form retrieval method for retrieval of an instruction form accessible to a user based on the user information.

According to one aspect of the present invention, the instruction form retrieval apparatus has: a storage part that stores user information and information on an instruction form management apparatus holding an instruction form accessible to the user, associated with each other, an input part that inputs the information on a user who instructs an instruction data execution apparatus to execute processing indicated in the instruction form; and a retrieval part that retrieves information on the instruction form management apparatus holding the instruction form accessible to the user based on the information on the user inputted by the input part.

According to another aspect of the present invention, the instruction form management system has: the above instruction form retrieval apparatus; at least one instruction form execution apparatus; and at least one instruction form management apparatus.

According to another aspect of the present invention, the instruction form execution apparatus has: an attachment part that attaches a storage medium, which is unique to a predetermined user, holding information on an instruction form management apparatus holding an instruction form accessible to the user, an input part that inputs the instruction form accessible to the user from the instruction form management apparatus, based on the information on the instruction form management apparatus; and an execution part that executes processing indicated in the input instruction form.

According to another aspect of the present invention, the instruction form management system has: at least one instruction form execution apparatus; a storage medium attached to the instruction form execution apparatus; and plural instruction form management apparatuses.

According to another aspect of the present invention, the instruction form retrieval method has: a step of storing information on a user and information on an instruction form management apparatus holding an instruction form accessible to the use, associated with each other, a step of inputting the information on the user to execute processing indicated in the instruction form by an instruction form execution apparatus; and a step of retrieving information on the instruction form management apparatus holding the instruction form accessible to the user based on the inputted information on the user.

According to another aspect of the present invention, the instruction form execution apparatus has: a storage part that stores user information and information on an instruction form management apparatus holding an instruction form accessible to the user, associated with each other, an input part that inputs the information on the user to execute processing indicated in the instruction form by an instruction form execution apparatus; a retrieval part that retrieves information on the instruction form management apparatus holding the instruction form accessible to the user based on the information on the user inputted by the input par and a processing part that executes the processing based on the instruction form accessible to the user retrieved by the retrieval part.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a configuration of an instruction form management system according to a first embodiment of the present invention;

FIG. 2 is an example of an instruction form according to the first embodiment of the present invention;

FIGS. 3A to 3C are flowcharts showing an operation according to the first embodiment of the present invention;

FIG. 4 is a block diagram showing the operation according to the first embodiment of the present invention;

FIGS. 5A to 5C are flowcharts showing the operation according to a modification to the first embodiment of the present invention;

FIG. 6 is a block diagram showing the operation according to the modification to the first embodiment of the present invention;

FIG. 7 is a block diagram showing the configuration of the instruction form management system according to a second embodiment of the present invention;

FIGS. 8A and 8B are flowcharts showing the operation according to the second embodiment of the present invention;

FIG. 9 is a block diagram showing the configuration of the instruction form management system according to a modification to the second embodiment of the present invention; and

FIG. 10 is a flowchart showing the operation according to the modification to the second embodiment of the present invention.

### DETAILED DESCRIPTION OF THE PREFERRED EMBODIMENTS

[First Embodiment]

Hereinbelow, a first embodiment of the present invention will be described with reference to the drawings.

(Configuration)

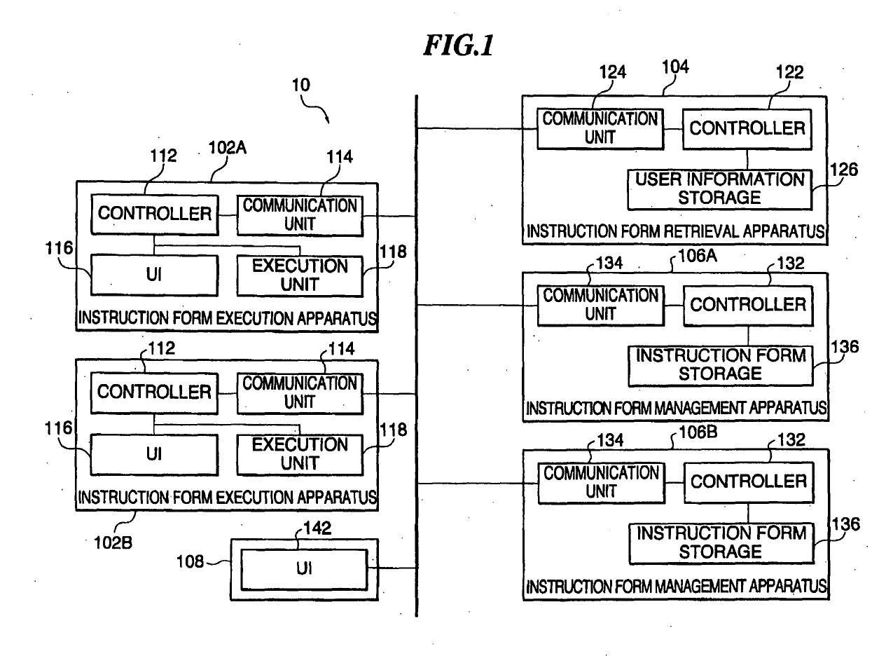

As shown in FIG. 1, an instruction form management system 10 according to the first embodiment includes plural instruction form execution apparatuses 102 (102A and 102B) to execute processing indicated in an instruction form, an instruction form retrieval apparatus 104 to retrieve the instruction form, and plural instruction form management apparatuses 106 (106A and 106B) to hold instruction forms. The instruction form execution t 102, the instruction form retrieval apparatus 104 and the instruction form management apparatuses 106 are interconnected via a network. The network may be the Internet or a LAN, otherwise a radio connection system such as Bluetooth.

The instruction form execution apparatus 102 has a user interface (UI) 116 such as a display and a keyboard for a user's operation of the instruction form execution apparatus 102, an execution unit 118 to execute processing indicated in an instruction form, a communication unit 114 to perform communication via the network, and a controller 112 to control the user interface 116, the execution unit 118 and the communication unit 114. The instruction form execution apparatus 102 may be a digital multiple function peripheral device or a personal computer connected to a peripheral device having a function of the execution unit The execution unit 118 may be an integrally-constructed device or a set of multiple devices having functions of image input/output, facsimile transmission, audio input/output and the like.

Further, it may be arranged such that a terminal apparatus 108 having a user interface 142 for the user's selection of instruction form is provided as an independent apparatus. The terminal apparatus 108 is connectable with the instruction form execution apparatus 102 and the instruction form retrieval apparatus 104 via the network.

The instruction form retrieval apparatus 104 has a user information storage 126 as a storage part that stores information on a user and information on an instruction form management apparatus holding an instruction form accessible to the user, associated with each other, a communication unit 124 as an input part and output part that perform communication via the network, and a controller 122 as a retrieval part that controls the user information storage 126 and the communication unit 124. The instruction form management apparatus 106 has an instruction form storage 136 for storing instruction forms, a communication unit 134 to perform communication via the network, and a controller 132 to control the instruction form storage 136 and the communication unit 134.

(Instruction Form)

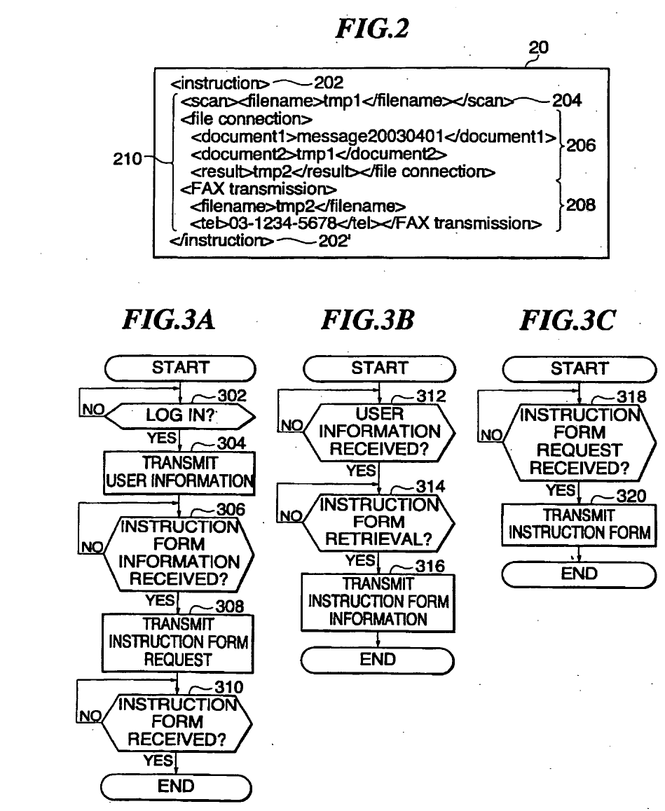

As shown in FIG. 2, an instruction form indicates processing to be executed by the instruction form execution apparatus 102. An instruction form 20 includes <instruction>202 and <instruction>202′ to indicate the start and the end of the instruction form, and a processing portion 210 as execution statements indicating processing to be executed by the instruction form execution apparatus 102. The instruction form 20 indicates processing to be executed by the execution unit 118 of the instruction form execution apparatus 102 including an image input/output unit, a file connection unit and a facsimile transmission unit. The processing portion 210 includes a scan processing portion 204 held between <scan> and </scan> indicating the start and the end of processing executed by the image input unit, a file connection processing portion 206 held between <file connection> and </file connection> indicating the start and the end of processing executed by the file connection unit, and a facsimile transmission processing portion 208 held between <FAX> and </FAX> indicating the start and the end of processing executed by the facsimile transmission unit.

Next, the execution of processing indicated in the instruction form 20 as shown in FIG. 2 by the instruction form execution apparatus 102 will be described in detail. The controller 112 instruct the image input unit to led an original based on a statement <filename> tmp1<filename> in the scan processing portion 204. The image input unit scans the original and stores it as a file “tmp1”.

Next, the controller 112 causes the file connection unit to processing in the file connection processing portion 206. The file connection unit reads files “communication document 20030401” and “tmp1” indicated in a first statement <document1> communication document20030401</document1> and a second statement <document2>tmp1</document2>, connects the files and stores it as a file “tmp2” indicated in a third statement <result>tmp2</result>.

Finally, the controller 112 causes the facsimile transmission unit to execute the processing in the facsimile transmission processing portion 208. The facsimile transmission unit facsimile-transmits the file “tmp2” indicated in a first statement <filename>tmp2</filename>to a telephone number “03-1234-5678” indicated in a second statement <te1>03-1234-5678</te1>.

The instruction form in FIG. 2 is described in the XML (eXtensible Markup Language), however, the present invention is not limited to this language. For example, the instruction form may be formed on a paper sheet as thumbnails image indicating processing contents and check boxes, such that the user checks a check box of processing to be executed by the execution part

(Operation)

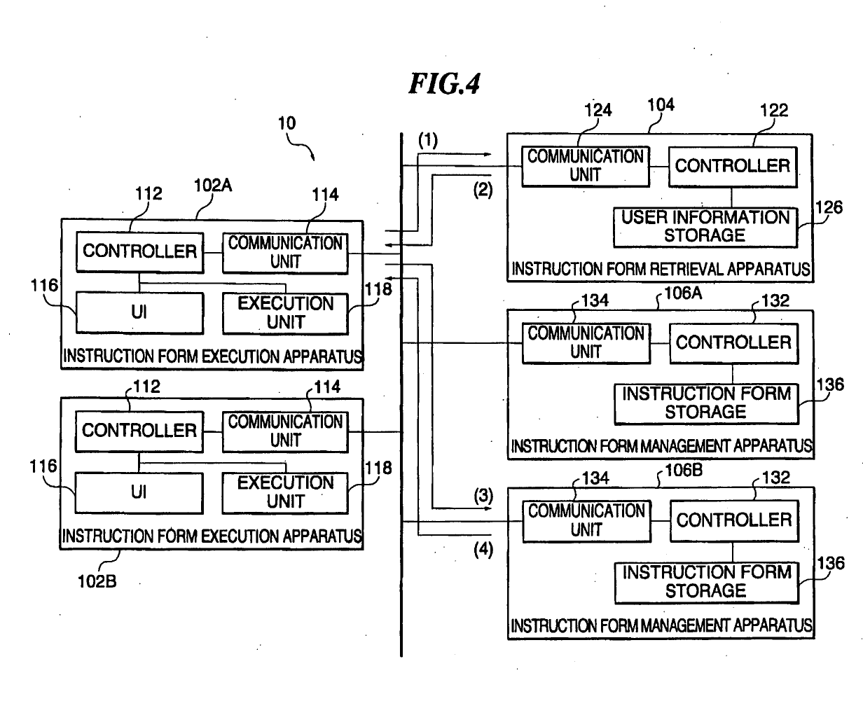

Next, an operation of the first embodiment will be described with reference to FIGS. 3A to 3C and FIG. 4. FIG. 3A shows processing in the instruction form execution apparatus 102, FIG. 3B, processing in the instruction form retrieval apparatus 104, and FIG. 3C, processing in the instruction form management apparatus 106.

An instruction form is generated in advance by the user or a system administrator and stored in the instruction form storage 136 of the instruction form management apparatus 106. Information on a user and information on an instruction form management apparatus holding an instruction form accessible to the user, associated with each other, are stored in the user information storage 126 of the instruction form retrieval apparatus 104.

At step 302, if it is deter that the user has performed an log-in operation to the instruction form execution apparatus 102A via the user interface 116 of the instruction form execution apparatus 102A, then at step 304, the instruction form execution apparatus 102A transmits the information on the user to the instruction form retrieval apparatus 104 via the network ((1) in FIG. 4). The log-in operation is made by the user's inputting the information on the user via the user interface 116 such as a keyboard. The information on the user may be a unique user ID or a password.

At step 312, when the communication unit 124 receives the information on the user, then at step 314, the controller 122 of the instruction form retrieval apparatus 104 retrieves information on an instruction form management apparatus holding an instruction form accessible to the user, based on the user information. That is, information on an instruction form management apparatus holding an instruction form accessible to the user, stored in the user information storage 126, associated with the information on the user, is retrieved.

If the information on an instruction form management apparatus holding an instruction form accessible to the user is retrieved, then at step 316, the communication unit 124 of the instruction form retrieval apparatus 104 transmits the retrieved information on the instruction form management apparatus to the instruction form execution apparatus 102A ((2) in FIG. 4). In a case where the instruction form accessible to the user is stored in the instruction form storage 136 of the instruction form management apparatus 106B, information on the instruction form management apparatus 106B is retrieved and transmitted to the instruction form execution apparatus 104A. The information on the instruction form management apparatus may be an EP (Internet Protocol) address or URL (Uniform Resource Locator), however, the present invention is not limited to this information.

Further, it may be arranged such that information such as instruction form names, locations, and names of instruction form management apparatuses holding instruction forms are listed and transmitted to the instruction form execution apparatus. In this case, the user can visually check, select and indicate information on an instruction form accessible to the user.

At step 306, when the information on the ins on form management apparatus 106B is received, then at step 308, the instruction form execution apparatus 102A accesses the instruction form management apparatus 106B using the information, and sends a command to the instruction form management apparatus to transmit the instruction form accessible to the user ((3) in FIG. 4). At step 318, when the command is received, then at step 320, the instruction form management apparatus 106B transmits the instruction form accessible to the user, stored in the instruction form storage 136, to the instruction form execution apparatus 102A ((4) in FIG. 4).

At step 310, when the instruction form execution apparatus 102A receives the instruction form, the process ends. The instruction form execution apparatus 102A can execute processing indicated in the received instruction form. The instruction form may be previously changed in advance to be applicable to an execution environment of the instruction form execution apparatus 102A.

Note that the instruction form accessible to the user may be a single instruction form, or may be plural instruction forms stored in plural instruction form management apparatuses. In the latter case, it may be arranged at step 320 such that the instruction form management apparatus 106 transmits a list of instruction forms in place of the instruction form to the instruction form execution apparatus 102.

In this manner, the user information storage of the instruction form retrieval apparatus 104 holds information on a user and information on an instruction form management apparatuses holing an instruction form accessible to the user, associated with each other, the communication unit 124 inputs the information on the user to use an instruction form execution apparatus to execute processing indicated in the instruction form and the controller 122 retrieves information on an instruction form management apparatus holding the instruction form accessible to the user, based on the information on the user inputted from the communication unit 124.

That is, as the storage part holds information on a user and information on an instruction form management apparatus holding an instruction form accessible to the user, associated with each other, the input part inputs the information on the user to use an instruction form execution apparatus to execute processing indicated in the instruction form, and the retrieval part retrieves information on an instruction form management apparatus holding the instruction form accessible to the user, based on the user information inputted from the communication unit, the user can easily retrieve information on the instruction form management apparatus holding the instruction form accessible to the user.

The communication unit 124 outputs the information on the instruction form management apparatus retrieved by the controller 122 to the instruction form execution apparatus 102 used by the user. That is, the output part outputs the information on the instruction form management apparatus retrieved by the retrieval part to the instruction form execution apparatus used by the user.

Generally, the instruction form is associated with the instruction form execution apparatus and not associated with a user. However, in an operating environment where plural apparatuses are interconnected via a network, a single user or a group of users use plural instruction form execution apparatuses. In this case, there is no big problem if an instruction form accessible to a user is stored in an instruction form execution apparatus used by the user. However, if the instruction form is stored in another apparatus, the user (1) detects the apparatus holding the instruction form, then (2) accesses the apparatus via the network, and (3) accesses the instruction form. The access to the instruction form via multiple steps impairs the advantage of instruction form of reduction of the load on the user and waiting time.

On the other hand, according to the present invention, as the instruction form is associated with not the instruction form execution apparatus but the user, even if the user uses any of plural instruction form execution apparatuses, the user can easily retrieve and use the instruction form accessible to the user. Further, in this arrangement, the instruction form is not necessarily stored in a single place but may be stored in any of the plural instruction form execution apparatuses, instruction form management apparatuses and storages.

[Modification]

(Operation)

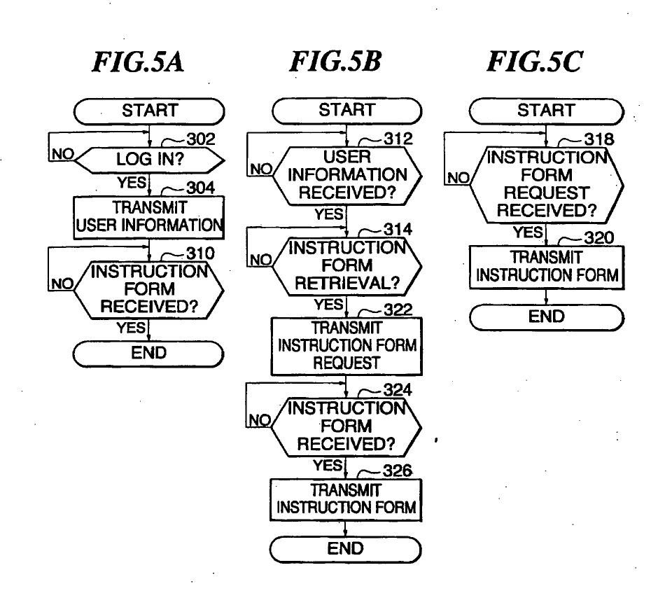

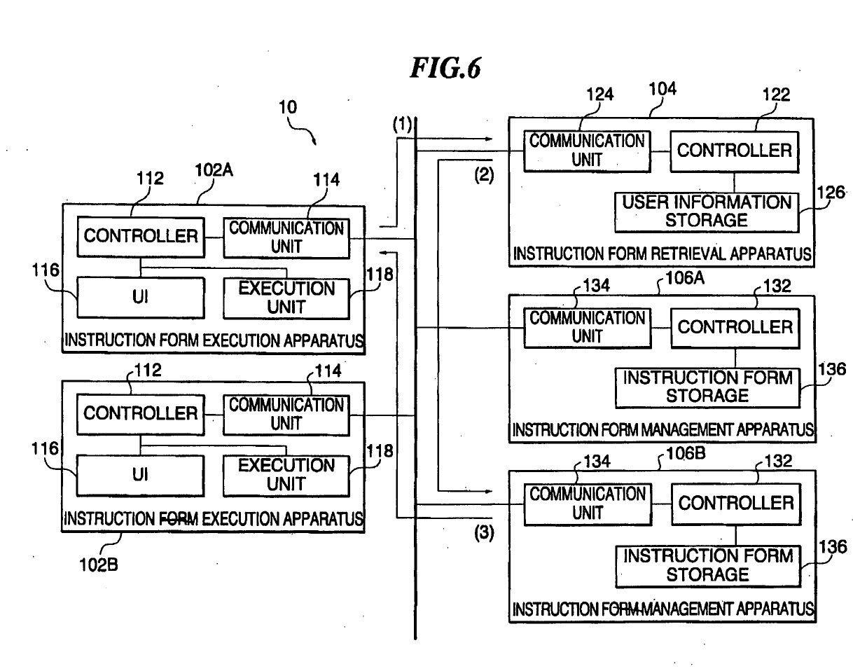

Next, an operation of a modification to the first embodiment will be described with reference to FIGS. 5A to 5C and FIG. 6. FIG. 5A shows processing in the instruction form execution apparatus 102, FIG. 5B, processing in the instruction form retrieval apparatus 104, and FIG. 5C, processing in the instruction form management apparatus 106. Note that as the construction of the first embodiment and that of the modification are the same, corresponding constituent elements have the same reference numerals and explanations thereof will be omitted. Further, in the modification, processing corresponding to that of the first embodiment has the same step numbers and explanation thereof will be omitted

At step 302, if it is determined that the user has performed a log-in operation on the instruction form execution apparatus 102A via the user interface 116 of the instruction form execution apparatus 102A, processes at steps 302 and 304 in the instruction form execution apparatus 102A ((1) in FIG. 6), and processes at steps 312 and 314 in the instruction form retrieval apparatus 104 are performed as in the case of the first embodiment. The login operation is made by the user's inputting the information on the user via the user interface 116 such as a keyboard. The information on the user may be a user-specific ID or a password.

In a case where the information on the instruction form management apparatus holding the instruction form accessible to the user is information on the instruction form management apparatus 106B, at step 322, the communication unit 124 of the instruction form retrieval apparatus 104 accesses the instruction form management apparatus 106B using the information, and transmits a command to transmit the instruction form accessible to the user to the instruction form execution apparatus 102A to the instruction form management apparatus 106B ((2) in FIG. 6).

At step 318, when the command is received, then at step 320, the instruction form management apparatus 106B transmits the instruction form accessible to the user, stored in the instruction form storage 136, to the instruction form execution apparatus 102A ((3) in FIG. 6). At step 310, when the instruction form execution apparatus 102A receives the instruction form, the process ends. The instruction form execution apparatus 102A can execute processing indicated in the received instruction form The instruction form may be changed in advance to be applicable to an execution environment of the instruction form execution apparatus 102A.

Note that the instruction form accessible to the user may be a single instruction form, or may be plural instruction forms stored in plural instruction form management apprises. In the latter case, it may be arranged at step 320 such that the instruction form management apparatus 106 transmits a list of instruction forms in place of the instruction form to the instruction form execution apparatus 102.

In this manner, the user information storage 126 of the instruction form retrieval apparatus 104 holds information on a user and information on the instruction form management apparatuses holing an instruction form accessible to the user associated with each other, the communication unit 124 inputs information on the user to use an instruction form execution apparatus 102 to execute processing indicated in the instruction form and the controller 122 retrieves information on an instruction form management apparatus holding the instruction form accessible to the user, based on the information on the user inputted from the communication unit 124.

That is, as the storage part holds information on a user and information on an instruction form management apparatus holding an instruction form accessible to the user, associated with each other, the input part inputs the information on the user to use the instruction form execution apparatus to execute processing indicated in the instruction form, and the retrieval part retrieves information on an instruction form management apparatus holding the instruction form accessible to the user, based on the information on the user inputted from the input part, the user can easily retrieve information on the instruction form management apparatus holding the instruction form accessible to the user.

The communication unit 124 of the instruction form retrieval apparatus 104 outputs a command to the instruction form management apparatus 106 to transmit the instruction form accessible to the user on the instruction form to the instruction form execution apparatus 102 used by the user, based on the retrieved information on the instruction form management apparatus.

In the first embodiment and the modification, for the sake of simplification of explanation, the instruction form management system 10 includes two instruction form execution apparatuses 102 and two instruction form management apparatuses 106, however, the present invention is not limited to this arrangement The system may include any number of apparatuses as long as it includes plural instruction form execution apparatuses 102 and plural instruction form management apparatuses 106. Further, the instruction form execution apparatus 102, the instruction form retrieval apparatus 104 and the instruction form management apparatus 106 are not necessarily independent single apparatuses. For example, the instruction form retrieval apparatus 104 may be included in the instruction form execution apparatus 102 or the instruction form management apparatus 106.

In the first embodiment, the instruction form execution apparatus 102 outputs a command to the instruction form management apparatus 106 to transmit an instruction form, and in the modification, the instruction form medieval apparatus 104 outputs a command to the instruction form management apparatus 106 to transmit an instruction form, and based the command, the instruction form management apparatus 106 transmits an instruction form accessible to the user to the instruction form execution apparatus 102. However, the present invention is not limited to this arrangement. For example, it may be arranged such that the instruction form management apparatus 106 transmits the instruction form accessible to the user to the instruction form execution apparatus 102 by obtaining information on the user who uses the instruction form execution apparatus 102.

The log-in operation at step 302 in the first embodiment and the modification is made by the user's inputting the information on the user via the user interface 116 such as a keyboard, however, the present invention is not limited to this arrangement, and the log-in operation may be performed by attachment of an IC card or USB key holding information on the user to the user interface 116 as a storage medium attachment unit

[Second Embodiment]

Hereinbelow, a second embodiment of the present invention will be described with reference to the drawings.

(Configuration)

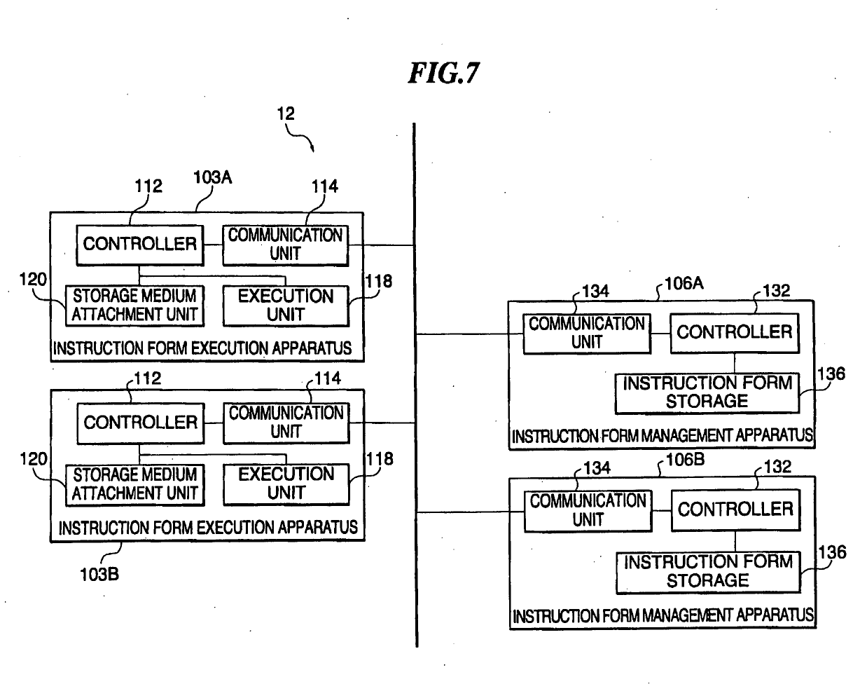

As shown in FIG. 7, an instruction form management system 12 according to the second embodiment includes plural instruction form execution apparatuses 103 (103A and 103B) to execute processing indicated in an instruction form and plural instruction form management apparatuses 106 (106A and 106B). The instruction form execution apparatuses 103 and the instruction form management apparatuses 106 are interconnected via a network The network may be the Internet or a LAN, otherwise, may be a radio connection system such as Bluetooth The instruction form management system 12, unlike the instruction form management system 10 of the first embodiment, does not have the instruction form retrieval apparatus 104.

The instruction form execution apparatus 103 has the execution unit 118 as an execution part that executes processing indicated in an instruction form, a communication unit 114 as an input part that performs communication via the network, a storage medium attachment unit 120 as an attachment part that attaches a storage medium, and the controller 112 to control the execution unit 118, the communication unit 114 and the storage medium attachment unit 120. The instruction form execution apparatus 103 may be a digital complex machine or a personal computer connected to a peripheral device having a function of the execution unit The execution unit 118 may be an integrally-constructed device or a set of multiple devices having functions of image input/output, facsimile transmission, audio input/output and the like. The instruction form execution apparatus 103 has the storage medium attachment unit 120 in place of the user interface 116 of the instruction form execution apparatus 102 of the first embodiment.

The instruction form management apparatus 106 has the instruction form storage 136 for storing an instruction form, the communication unit 134 to perform communication via the network and the controller 132 to control the instruction form storage 136 and the communication unit 134.

(Operation)

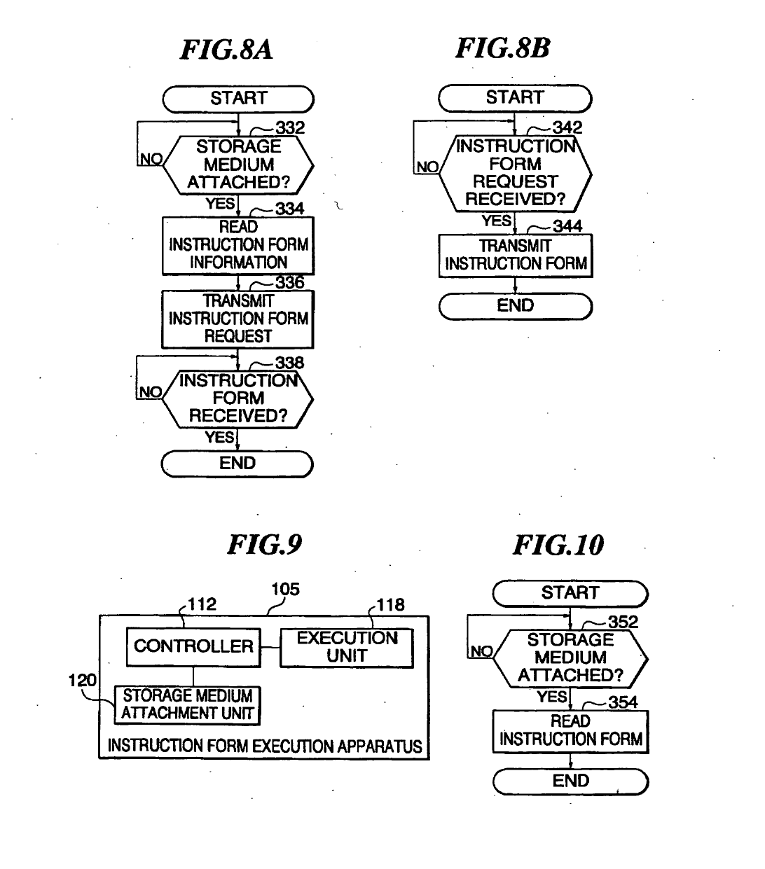

Next, the operation of the second embodiment will be described with reference to FIGS. 8A and 8B. FIG. 8A shows processing in the instruction form execution apparatus 103, and FIG. 8B, processing in the instruction form management apparatus 106.

An instruction form is generated in advance by the user or a system administrator and stored in the instruction form storage 136 of the instruction form management apparatus 106. The user has a storage medium unique to the users and information on an instruction form management apparatus holding an instruction form accessible to the user is stored in the storage medium. The storage medium may be an IC card or a USB key, however, the present invention is not limited to these media.

At step 332, if it is determined that the user has attached the storage medium unique to the user to the storage medium attachment unit 120 of the instruction form execution apparatus 103A, then at step 334, the controller 112 reads the information on the instruction form management apparatus holding the instruction form accessible to the user from the storage medium. If the instruction form management apparatus holding the instruction form accessible to the user is the instruction form management apparatus 106B, then at step 336, the instruction form execution apparatus 103A accesses the instruction form management apparatus 106B using the information, and transmits a command to the instruction form management apparatus 106B to transmit the instruction form accessible to the user. The information on the instruction form management apparatus may be an 1P (Internet Protocol) address, URL (Uniform Resource Locator or the like, however, the present invention is not limited to information as such.

At step 342, when the command is received, and at step 344, the instruction form management apparatus 106B transmits the instruction form accessible to the user stored in the instruction form storage 136 to the instruction form execution apparatus 103A. At step 338, when the instruction form execution apparatus 103A receives the instruction form, the process ends. The execution unit 118 of the instruction form execution apparatus 103A can execute processing indicated in the instruction form The instruction form may be previously changed in advance to be applicable to an execution environment of the instruction form execution apparatus 103A.

Note that the instruction form accessible to the user may be a single instruction form, or may be plural instruction forms stored in plural instruction form management apparatuses. In the latter case, it may be arranged at step 344 such that the instruction form management apparatus 106 transmits a list of instruction forms in place of the instruction form to the instruction form execution apparatus 103.

In this manner, a storage medium available a user, holding information on an instruction form management apparatus holding an instruction form accessible to the user, is attached to the storage medium attachment unit 120, and the communication unit 114 inputs the instruction form accessible to the user from the instruction form management apparatus 106 based on the information on the instruction form management apparatus, and the execution unit 118 executes processing indicated in the input instruction form.

That is, a storage medium unique to a user, holding information on an instruction form management apparatus holding an instruction form accessible to the user, is attached to the attachment part, then the input part inputs the instruction form accessible to the user from the instruction form management apparatus based on the information on the instruction form management apparatus, and the execution part executes processing indicated in the input instruction form, the user can easily access the instruction form accessible to the user.

In the second embodiment, for the sake of simplification of explanation, the instruction form management system 12 includes two instruction form execution apparatuses 103 and two instruction form management apparatuses 106, however, the present invention is not limited to this arrangement. The system may include any number of apparatuses as long as it includes plural instruction form execution apparatus 103 and plural instruction form management apparatuses 106. Further, the instruction form execution apparatus 103, and the instruction form management apparatus 106 are not necessarily independent single apparatuses. For example, the instruction form management apparatus 106 may be included in the instruction form execution apparatus 103.

In the second embodiment, the instruction form execution apparatus 103 outputs a command to the instruction form management apparatus 106 to transmit an instruction form, and based the command, the instruction form management apparatus 106 transmits an instruction form accessible to the user to the instruction form execution apparatus 103. However, the present invention is not limited to this arrangement For example, it may be arranged such that the instruction form management apparatus 106 transmits the instruction form accessible to the user to the instruction form execution apparatus 103 by obtaining information on the user who uses the instruction form execution apparatus 103.

[Modification]

(Configuration)

Hereinbelow, a modification to the second embodiment of the present invention will be described with reference to the drawings.

As shown in FIG. 9, an instruction form execution apparatus 105 according to the modification to the second embodiment has the execution unit 118 to execute processing indicated in an instruction form, the storage medium attachment unit 120 for attachment of a storage medium and the controller 112 to control the execution unit 118 and the storage medium attachment unit 120. The instruction form execution apparatus 105 may be a digital multiple function peripheral device or a personal computer connected to a peripheral device. The execution unit 118 maybe an integrally-constructed device or a set of multiple devices having functions of image input/output, facsimile transmission, audio input/output and the like.

(Operation)

Next, the operation of the modification to the second embodiment will be described with reference to FIG. 10.

The user has a storage medium unique to the user, and an instruction form accessible to the user, generated in advance by the user or a system administrator, is stored in the storage medium. The storage medium may be an IC card or a USB key, however, the present invention is not limited to these media.

At step 352, if it is determined that the storage medium unique to the user has been attached to the storage medium attachment unit 120 of the instruction form execution apparatus 105, then at step 354, the controller 112 reads an instruction form unique to the user form the storage medium, and the process ends. The instruction form execution apparatus 105 can execute processing indicated in the read instruction form. The instruction form may be previously changed in advance to be applicable to an execution environment of the instruction form execution apparatus 105.

In this manner, as a storage medium unique to a user is attached to the storage medium attachment unit 120 of the instruction form execution apparatus 105, and the storage medium holds an instruction form accessible to the user, even in a case where the user uses any one of plural instruction form execution apparatuses 105, the user can utilize the instruction form accessible to the user.

As described above, according to the present invention, the storage part of the instruction form retrieval apparatus holds information on a user and information on an instruction form management apparatus holding an instruction form accessible to the user, associated with each other, the input part inputs the information on the user who uses an instruction form execution apparatus to execute processing indicated in the instruction form, and the retrieval part retrieves the information on the instruction form management apparatus holding the instruction form accessible to the user based on the information on the user inputted by the input part, the user can easily retrieve the information on the instruction form management apparatus holding the instruction form accessible to the user.

The entire disclosure of Japanese Patent Application No. 2003-081354 filed on Mar. 24, 2003 including specification, claims, drawings and abstract is incorporated herein by reference in its entirety.

What is claimed is:

1. An instruction form retrieval apparatus comprising:
a storage part that stores user information and information on an instruction form management apparatus holding an instruction form accessible to the user, associated with each other,
an input part that inputs information on a user who instructs an instruction form execution apparatus to execute processing indicated in the instruction form; and
a retrieval part that retrieves information on the instruction form management apparatus holding the instruction form accessible to the user based on the information on the user input by the input part.

2. The instruction form retrieval apparatus according to claim 1, further comprising an output part that outputs information on the instruction form management apparatus retrieved by the retrieval part to the instruction form execution apparatus used by the user.

3. The instruction form retrieval apparatus according to claim 1, further comprising an output part that outputs the information on the instruction form management apparatus retrieved by the retrieval part to a terminal used by the user.

4. The instruction form retrieval apparatus according to claim 1, further comprising an output part that outputs a command to the instruction form management apparatus to transmit the instruction form accessible to the user to the instruction form execution apparatus used by the user, based on the information on the instruction form management apparatus retrieved by the retrieval part.

5. The instruction form retrieval apparatus according to claim 1, further comprising an output part that outputs a command to the instruction form management apparatus to transmit the instruction form accessible to the user to a terminal used by the user, based on the information on the instruction form management apparatus retrieved by the retrieval part.

6. The instruction form retrieval apparatus according to claim 2, wherein the information on the instruction form management apparatus output from the output part is information on the instruction form management apparatus holding the instruction form.

7. The instruction form retrieval apparatus according to claim 2, wherein the information on the instruction form management apparatus outputted from the output part includes information to discriminate the instruction form.

8. The instruction form retrieval apparatus according to claim 1, wherein user authentication is performed using the information on the user.

9. The instruction form retrieval apparatus according to claim 1, further comprising a display information generation part that generates information to display the retrieved information on the instruction form management apparatus.

10. An instruction form management system comprising:
an instruction form retrieval apparatus;
at least one instruction form execution apparatus; and
at least one instruction form management apparatus,
wherein the instruction form retrieval apparatus comprises:
a storage part that stores user information and information on the instruction form management apparatus holding an instruction form accessible to the user, associated with each other,
an input part that inputs information on a user who instructs the instruction form execution apparatus to execute processing indicated in the instruction form; and
a retrieval part that retrieves information on the instruction form management apparatus holding the instruction form accessible to the user based on the information on the user input by the input part.

11. An instruction form execution apparatus comprising:
an attachment part that attaches a storage medium, which is unique to a predetermined user, holding information on an instruction form management apparatus holding an instruction form accessible to the user,
an input part that inputs the instruction form accessible to the user from the instruction form management apparatus, based on the information on the instruction form management apparatus; and
an execution part that executes processing indicated in the input instruction form.

12. An instruction form management system comprising
at least one instruction form execution apparatus;
a storage medium attached to the instruction form execution apparatus; and
plural instruction form management apparatuses,
wherein the at least one instruction form execution apparatus comprises:
an attachment part that attaches a storage medium, which is unique to a predetermined user, holding information on each of the instruction form management apparatuses holding an instruction form accessible to the user;
an input part that inputs the instruction form accessible to the user from each of the instruction form management apparatuses, based on the information on each instruction form management apparatus; and
an execution part that executes processing indicated in the input instruction form.

13. An instruction form retrieval method comprising:
storing user information and information on an instruction form management apparatus holding an instruction form accessible to the user, associated with each other,
inputting the information on the user to execute processing indicated in the instruction form by an instruction form execution apparatus; and
retrieving information on the instruction form management apparatus holding the instruction form accessible to the user based on the inputted information on the user.

14. The instruction form retrieval method according to claim 13, further comprising outputting the retrieved information on the instruction form management apparatus to the instruction form execution apparatus used by the user.

15. The instruction form retrieval method according to claim 13, further comprising outputting a command to the instruction form management apparatus to transmit the instruction form accessible to the user to the instruction form execution apparatus used by the user, based on the retrieved information on the instruction form management apparatus.

16. An instruction form execution apparatus comprising:
a storage part that stores user information and information on an instruction form management apparatus holding an instruction form accessible to the user, associated with each other,
an input part that inputs the information on the user to execute processing indicated in the instruction form by an instruction form execution apparatus;
a retrieval part that retrieves information on the instruction form management apparatus holding the inspection form accessible to the user based on the information on the user inputted by the input part; and
a processing part that executes the processing based on the instruction form accessible to the user retrieved by the retrieval part.
